(19) United States
(12) Patent Application Publication
(10) Pub. No.: US 2010/0001902 A1
(43) Pub. Date: Jan. 7, 2010

(54) Situation awareness display

(75) Inventor: Michael Allen Smith, Freeburg, IL (US)

Correspondence Address: HUGH P. GORTLER, 23 Arrivo Drive, Mission Viejo, CA, 92692, US

(73) Assignee: The Boeing Company

(21) Appl. No.: 11/040,888

(22) Filed: Jan. 21, 2005

(51) Int. Cl. G01S 5/00

(52) U.S. Cl. 342/357.07

(57) ABSTRACT

Methods, systems, and articles of manufacture consistent with the present invention provide for tracking unmanned air vehicles and an observation platform. A location of an unmanned air vehicle is received wirelessly from the unmanned air vehicle, the location of the unmanned air vehicle being determined by a global positioning system on the unmanned air vehicle. A location of an observation platform is received from the observation platform, the location of the observation platform being determined by a global positioning system on the observation platform. The unmanned air vehicle and the observation platform are displayed on a display device based on the received location of the unmanned air vehicle and the received location of the observation platform.

### BACKGROUND OF THE INVENTION

The present invention generally relates to the field of vehicle tracking and, more particularly, to a situation awareness display that tracks unmanned air vehicles and observation platforms using their global positioning system data.

The use of unmanned air vehicles (UAVs) has been increasing, particularly for reconnaissance, military and scientific applications. Tracking of the unmanned air vehicles is typically performed by an observer on the ground or on an observation platform, such as a chase plane that flies in the vicinity of the unmanned air vehicles. To track the unmanned air vehicles, the observer conventionally uses sight or radar. It can be difficult to track unmanned air vehicles using sight, however, due to poor vision caused by environmental conditions or obstructions in the line of sight. Further, when multiple unmanned air vehicles are being tracked, the observer may lose sight of one or more of the vehicles.

### SUMMARY OF THE INVENTION

Methods, systems, and articles of manufacture consistent with the present invention provide for tracking unmanned air vehicles and an observation platform. A user can view the location and status of the unmanned air vehicles and the observation platform using a situation awareness display. The situation awareness display is a data processing system, such as a laptop computer, that includes a display device for viewing information about the unmanned air vehicles and the observation platform. The user can view the situation awareness display from a fixed or moving position that is local to or remote from the observation platform.

The unmanned air vehicles and the observation platform each have a global positioning system that determines their respective locations. They wirelessly transmit their locations and other data to the situation awareness display, which stores the received information in memory. The situation awareness display retrieves the received information from memory and displays the information on the display device for presentation to the user.

Therefore, unlike conventional methods and systems that rely on line of sight or radar, methods, systems and articles of manufacture consistent with the present invention use global positioning system data received from the unmanned air vehicles and observation platform to track the unmanned air vehicles and observation platform. Thus, a user of the situation awareness display consistent with the present invention is not hindered by viewing obstructions or the disadvantages of radar.

In accordance with methods consistent with the present invention, a method in a data processing system having a program for tracking an unmanned air vehicle is provided. The method comprises the steps of: receiving a location of an unmanned air vehicle wirelessly from the unmanned air vehicle, the location of the unmanned air vehicle being determined by a global positioning system on the unmanned air vehicle; receiving a location of an observation platform from the observation platform, the location of the observation platform being determined by a global positioning system on the observation platform; and displaying the unmanned air vehicle and the observation platform based on the location of the unmanned air vehicle and the location of the observation platform.

In accordance with articles of manufacture consistent with the present invention, a computer-readable medium containing instructions that cause a data processing system having a program to perform a method for tracking an unmanned air vehicle is provided. The method comprises the steps of: receiving a location of an unmanned air vehicle wirelessly from the unmanned air vehicle, the location of the unmanned air vehicle being determined by a global positioning system on the unmanned air vehicle; receiving a location of an observation platform from the observation platform, the location of the observation platform being determined by a global positioning system on the observation platform; and displaying the unmanned air vehicle and the observation platform based on the location of the unmanned air vehicle and the location of the observation platform.

In accordance with systems consistent with the present invention, a system for tracking an unmanned air vehicle is provided. The system comprises a memory having a program that: receives a location of an unmanned air vehicle wirelessly from the unmanned air vehicle, the location of the unmanned air vehicle being determined by a global positioning system on the unmanned air vehicle; receives a location of an observation platform from the observation platform, the location of the observation platform being determined by a global positioning system on the observation platform; and displays the unmanned air vehicle and the observation platform based on the location of the unmanned air vehicle and the location of the observation platform. A processing unit runs the program.

In accordance with systems consistent with the present invention, a system for tracking an unmanned air vehicle is provided. The system comprises: means for receiving a location of an unmanned air vehicle wirelessly from the unmanned air vehicle, the location of the unmanned air vehicle being determined by a global positioning system on the unmanned air vehicle; means for receiving a location of an observation platform from the observation platform, the location of the observation platform being determined by a global positioning system on the observation platform; and means for displaying the unmanned air vehicle and the observation platform based on the location of the unmanned air vehicle and the location of the observation platform.

In accordance with systems consistent with the present invention, a system for tracking an unmanned air vehicle is provided. The system comprises a display device remote from the unmanned air vehicle that displays a position of the unmanned air vehicle and a position of an observation platform, the position of the unmanned air vehicle being determined by a global positioning system on the unmanned air vehicle and received wirelessly from the unmanned air vehicle, the position of the observation platform being determined by a global positioning system on the observation platform and received from the observation platform.

Other features of the invention will become apparent to one with skill in the art upon examination of the following figures and detailed description. It is intended that all such additional systems, methods, features and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 is a diagram of a system for tracking unmanned air vehicles consistent with the present invention;

FIG. 2 is a block diagram of a situation awareness display data processing system consistent with the present invention;

FIG. 3 is a block diagram of a unmanned air vehicle or observation platform data processing system consistent with the present invention;

FIG. 4 is a flow diagram of exemplary steps performed by the update program consistent with the present invention;

FIG. 5 is a block diagram of a block of memory in the situation awareness display data processing system consistent with the present invention;

FIG. 6 is a flow diagram of exemplary steps performed by the view class consistent with the present invention;

FIG. 7 is a flow diagram of exemplary steps performed by the OnDraw function consistent with the present invention;

FIG. 8 is a flow diagram of exemplary steps performed by the HandleData function consistent with the present invention;

FIG. 9 is a screen shot displaying view mode menu selections;

FIG. 10 is a screen shot displaying zoom mode menu selections;

FIG. 11 is a screen shot displaying additional zoom mode menu selections;

FIG. 12 is a screen shot displaying overlay menu selections;

FIG. 13 is a screen shot displaying heads-up-display selections;

FIG. 14 is a screen shot displaying end mission selections;

FIG. 15 is a screen shot displaying an unmanned air vehicle, an observation platform, and the unmanned air vehicle's waypoints; and

FIG. 16 is a flow diagram of exemplary steps performed by the MainFrame class consistent with the present invention.

### DETAILED DESCRIPTION OF THE INVENTION

Reference will now be made in detail to an implementation in accordance with methods, systems, and articles of manufacture consistent with the present invention as illustrated in the accompanying drawings. Wherever possible, the same reference numbers will be used throughout the drawings and the following description to refer to the same or like parts.

Methods, systems, and articles of manufacture consistent with the present invention provide for tracking unmanned air vehicles and an observation platform. A user can view the location and status of the unmanned air vehicles and the observation platform using a situation awareness display. The user can view the situation awareness display from a fixed or moving position that is local to or remote from the observation platform. The unmanned air vehicles and the observation platform each have a global positioning system that determines their respective locations. They transmit their locations and other data to the situation awareness display, where the information is stored in memory. The situation awareness display retrieves the received information from memory and displays the information on the display device for presentation to the user. Thus, unlike conventional methods and systems, the user is not hindered by viewing obstructions or the disadvantages of radar.

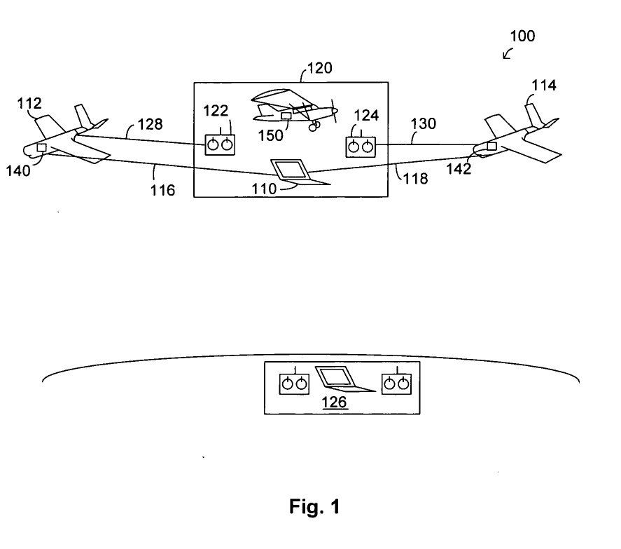

FIG. 1 is a schematic diagram of an illustrative system 100 including a situation awareness display 110 consistent with the present invention. The illustrative system 100 generally comprises one or more unmanned air vehicles (UAVs) 112 and 114. As will be described in more detail below, each unmanned air vehicle 112 and 114 includes a UAV data processing system 140 and 142, respectively, that communicates with one or more situation awareness displays, such as situation awareness display 110, via data links 116 and 118. The situation awareness display 110 is located on an observation platform 120, which is a chase plane in the illustrative example. One having skill in the art will appreciate that the observation platform is not limited to being a chase plane. For example, the observation platform can be, but is not limited to, a land vehicle, a ship, a spacecraft, a building, or a person. An alternative observation platform 126 is illustratively shown. Although the observation platform is named an “observation” platform, it is not necessary for the observer using the situation awareness display to see the physical aircraft that are displayed on the situation awareness display. Further, the situation awareness display can be at a different location than the observation platform.

In the illustrative example, the observation platform includes controls 122 and 124 for remotely controlling the respective unmanned air vehicles via control links 128 and 130. The control links can be, for example, 72 MHz radio signals. The data links can be, for example, 900 MHz signals using the iLink protocol. Alternatively, the control links and data links can be other types of signals and use other protocols. Each unmanned air vehicle includes a data processing system 140 and 142, respectively. And the observation platform includes a data processing system 150. The unmanned air vehicle and observation platform data processing systems acquire data about the unmanned air vehicle or observation platform and transmit the data to the situation awareness display. The respective data processing systems can also receive information from the situation awareness display.

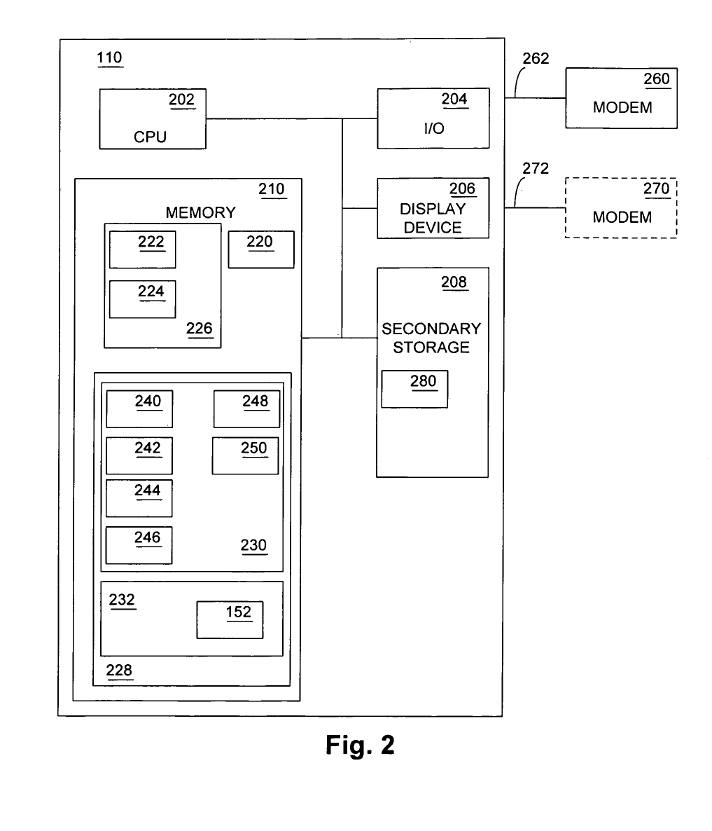

FIG. 2 depicts situation awareness display 110, in more detail, and modems 260 and 270. The situation awareness display is a data processing system that comprises a central processing unit (CPU) or processor 202, a display device 204, an input/output (I/O) unit 206, a secondary storage device 208, and a memory 210. The situation awareness display may further comprise standard input devices such as a keyboard, a mouse or a speech processing means (each not illustrated). In the illustrative example, the situation awareness display is a laptop computer, however, the situation awareness display is not limited to being a laptop computer.

Memory 210 comprises an update program 220 that receives unmanned air vehicle data 222 and observation platform data 224, and stores each of these data in a shared memory portion 226 of memory 210. The memory also includes a situation awareness display program 228 that includes a view class 230 and a main frame class 232, which together provide information on the display device for a user. As will be described in more detail below, the update program writes the various data to predetermined memory locations. The view class periodically checks for new data at these memory locations, and uses the data to update the display device.

Modem 260 receives data that is wirelessly transmitted from the unmanned air vehicles, and transmits the data to the situation awareness display. In the illustrative example, modem 260 receives data from each unmanned air vehicle as radio frequency (RF) signals. Modem 260 converts the received data from the wireless transmission protocol to a serial communication stream that is transmitted via a serial communication data link 262 to input/output device of the situation awareness display.

Similarly, the situation awareness display receives data from the observation platform via a serial communication data link 272. In the illustrative example, the situation awareness display is located on the observation platform. Data processing system 150, which is located in the observation platform, sends observation platform data via data link 272 to the situation awareness display. Transmission over data link 272 can be via, for example, a serial communication cable. However, if the situation awareness display is located remote from the observation platform, a modem 270 can receive data that is wirelessly transmitted from the observation platform. Modem 270 can convert the received data into a serial communication stream that is transmitted over serial communication data link 272 to the situation awareness display. Accordingly, the observation can also have a modem for wirelessly transmitting the observation platform data to modem 270. The transmission of data via data links 262 and 272 can be via a suitable communication protocol, such as for example, the RS-232 protocol.

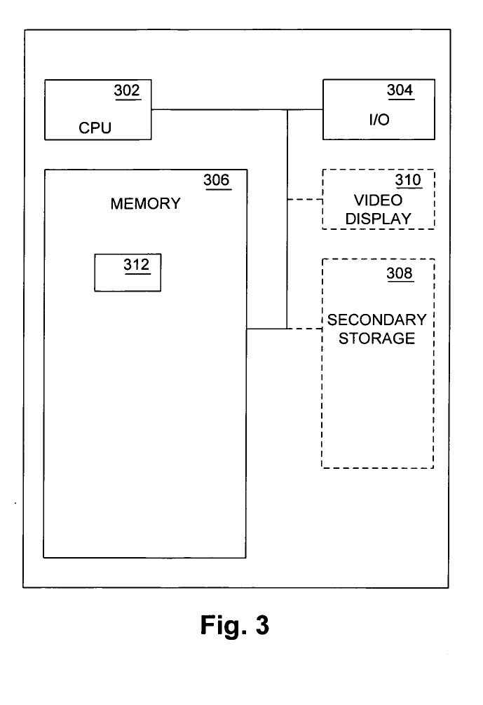

FIG. 3 depicts, in more detail, a schematic block diagram of a data processing system, such as unmanned air vehicle data processing systems 140 or 142 or observation platform data processing system 150. For illustrative purposes, data processing system 140 is described, however, data processing systems 142 and 150 can be similarly configured. Data processing system 140 comprises a central processing unit (CPU) or processor 302, an input/output (I/O) unit 304, and a memory 306. In an embodiment, data processing system can also include a secondary storage device 308 and a display device 310, however, a secondary storage and a display device are optionally included in the illustrative example and are thus shown in phantom lines. The data processing system may further comprise standard input devices such as a keyboard, a mouse or a speech processing means (each not illustrated). Memory 310 comprises a status program 312 that receives data about the unmanned air vehicle or observation platform from, for example, sensors and a global positioning system, and transmits the data to the situation awareness display. The data can be transmitted via, for example, serial communication link or via a modem.

In the illustrative example, the update program and the situation awareness display program are implemented in the Visual C++® programming language and for use with Microsoft® Windows® operating system. The situation awareness display program classes are implementations of the Boeing's Autometric™ classes. The status program can be implemented in any suitable programming language. One having skill in the art will appreciate that the programs can be implemented in one or more other programming languages and for use with other operating systems. Microsoft, Visual C++ and Windows are registered trademarks of Microsoft Corporation of Redmond, Wash., USA. Autometric is a trademark of the Boeing Company of Chicago, Ill. Other names used herein may be trademarks or registered trademarks of their respective owners.

One having skill in the art will appreciate that the various programs can reside in memory on a system other than the depicted data processing systems. The programs may comprise or may be included in one or more code sections containing instructions for performing their respective operations. While the programs are described as being implemented as software, the present implementation may be implemented as a combination of hardware and software or hardware alone. Also, one having skill in the art will appreciate that the programs may comprise or may be included in a data processing device, which may be a client or a server, communicating with the respective data processing system.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of data processing systems have been described, one having skill in the art will appreciate that a data processing system suitable for use with methods, systems, and articles of manufacture consistent with the present invention may contain additional or different components.

The data processing systems can also be implemented as client-server data processing systems. In that case, one or more of the programs can be stored on the respective data processing system as a client, while some or all of the steps of the processing described below can be carried out on a remote server, which is accessed by the client over a network. The remote server can comprise components similar to those described above with respect to the data processing system, such as a CPU, an I/O, a memory, a secondary storage, and a display device.

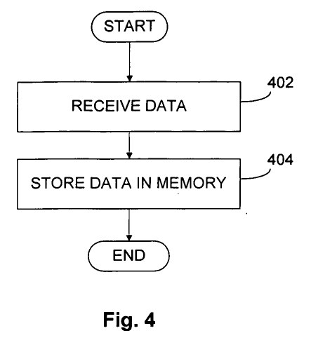

FIG. 4 depicts a flow diagram illustrating exemplary steps performed by the update program in the memory of the situation awareness display. As shown, the update program receives data from an unmanned air vehicle or the observation platform (step 402). The data is received via data link 262 or 272, which are connected to the I/O device. The data can include information about the unmanned air vehicles and the observation platform, such as latitude, longitude, altitude, and waypoints. Additional or alternative information can be received.

The status programs on the unmanned air vehicles and observation platform obtain data about their respective positions from sensors and global positioning systems on the respective platforms, and transmit the data to the situation awareness. The situation awareness display's update program receives the data and then writes the data to predetermined locations in memory (step 404). The various data items are written to predetermined memory locations so that view class 230 knows where to retrieve the data for a respective unmanned air vehicle or observation platform from memory.

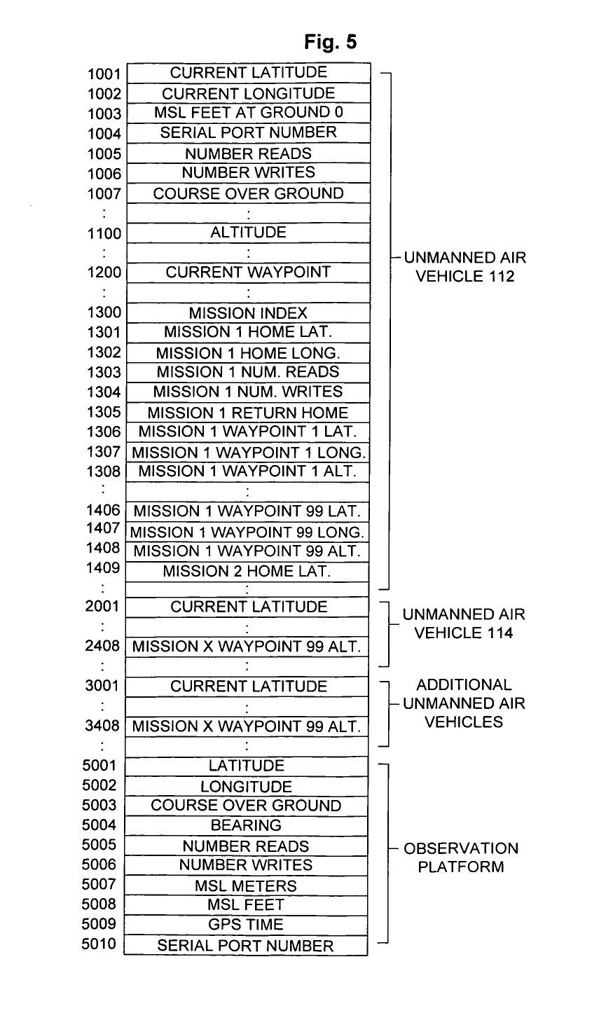

FIG. 5 depicts an illustrative block of memory that hold the data received by the update program. As shown, data for unmanned air vehicle 112 is stored in memory locations 1001-2000, data for unmanned air vehicle 114 is stored in memory locations 2001-3000, and data for the observation platform is stored in memory locations 5001-5010. Data for additional unmanned air vehicles can be stored in memory locations 3001-5000.

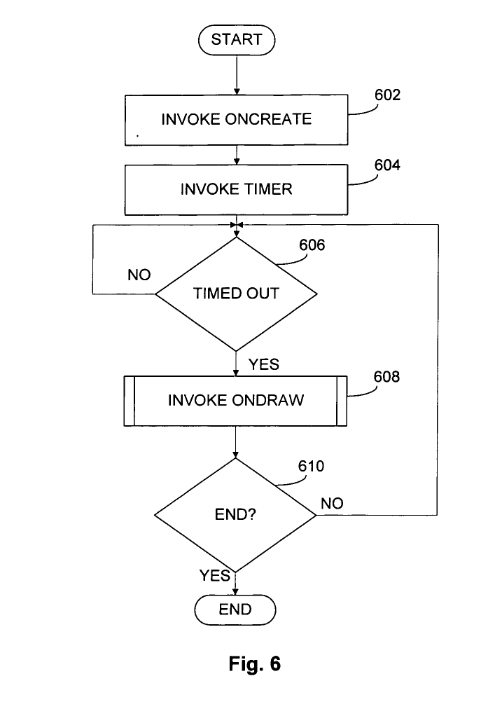

Referring to FIG. 2, view class 228 includes illustrative functions OnCreate 240, Timer 242, OnDraw 244, Menu functions 246, HandleData 248 and HotasText 250. As will be described in more detail below with reference to FIG. 6, OnCreate 240 provides default parameters for display when the view class is instantiated. OnCreate also invokes the Timer function. The Timer function is a watchdog timer that times to a predetermined period. When the Timer function times out, the OnDraw function is invoked. OnDraw invokes HandleData to retrieve current unmanned air vehicle and observation platform data, and updates the display of the situation awareness display. HandleData invokes HotasText to convert the data read, from the memory into drawable text that can be displayed on the situation awareness display. The Menu functions provide user selectable menu and toolbar functionality on the display of the situation awareness display. The main frame class and view class comprise various Menu functions, which may be invoked when a menu or toolbar resource is called. The Menu functions of the main frame class are shown as item 152 in FIG. 2. Illustrative menu functions of the view class and main frame class are listed below in Table 1.

TABLE 1
Menu Functions

| Main frame class menu functions: | View class menu functions: |
|---|---|
| Set zoom factor | Set zoom factor |
| Update zoom factor | Update zoom factor |
| Set JPG overlay | Set JPG overlay |
| Update JPG overlay | Update JPG overlay |
| Set CADRG overlay | Set CADRG overlay |
| Update CADRG overlay | Update CADRG overlay |
| Set HUD output | Set HUD output |
| Update HUD output | Update HUD output |
| View pushbutton bars | |
| Update pushbutton bars | |
| Set North up mode | Set North up mode |
| Update North up mode | Update North up mode |
| User guide | |
| Unmanned air vehicle address | Unmanned air vehicle address |
| Update unmanned air vehicle | Update unmanned air vehicle |
| address | address |
| Pop chute | Pop chute |
| Update pop chute | Update pop chute |
| Return home | Return home |
| Update return home | Update return home |
| | HotasText |
| | HandleData |

The illustrative menu functions of Table 1 are briefly described as follows. The set and update zoom factor functions set and update the zoom factor of the image on the display. The set and update JPG overlay functions set and update JPG overlay image information, such as an aerial or satellite photo of an area, on the display. The set and update CADRG overlay functions set and update a map image on the display. The set and update HUD output functions set and update heads-up-display information on the display. The view and update pushbutton bars functions toggle display of menu pushbuttons on the display. The set and update North up mode functions update the view mode of the display. The user guide function displays a user guide. The unmanned air vehicle address and update unmanned air vehicle address functions select one of the unmanned air vehicles. The pop chute and update pop chute functions instruct an unmanned air vehicle to pop its parachute. The return home and update return home functions instruct an unmanned air vehicle to return to its takeoff location. Each of these functions will be described in more detail below.

FIG. 6 is a flow diagram illustrating exemplary steps performed by the view class for updating the situation awareness display. As shown, the view class initially invokes the OnCreate function, which provides configuration values for the display when the situation awareness display is first started (step 602). In the illustrative example, the configuration values are default values in memory, however, the configuration values can be retrieved from another location, such as a configuration file 280 in secondary storage. The configuration values include, for example, viewpoint latitude, longitude, altitude, zoom, and where to find the map and overlay information. The configuration values can be updated, for example, at the end of a session, so that when the view class is re-invoked, the display returns to its previous configuration. For example, the configuration values may identify that the display is oriented to point north, to display a particular map with no overlay, and to display the map with a zoom factor of 2.

After retrieving the configuration values, OnCreate invokes the Timer function (step 604). In the illustrative example, the Timer function is watchdog timer that times down to 0 seconds from a predetermined value, such as 5 milliseconds. When the view class determines that the watchdog timer has timed out (step 606), the view class invokes the OnDraw function (step 608).

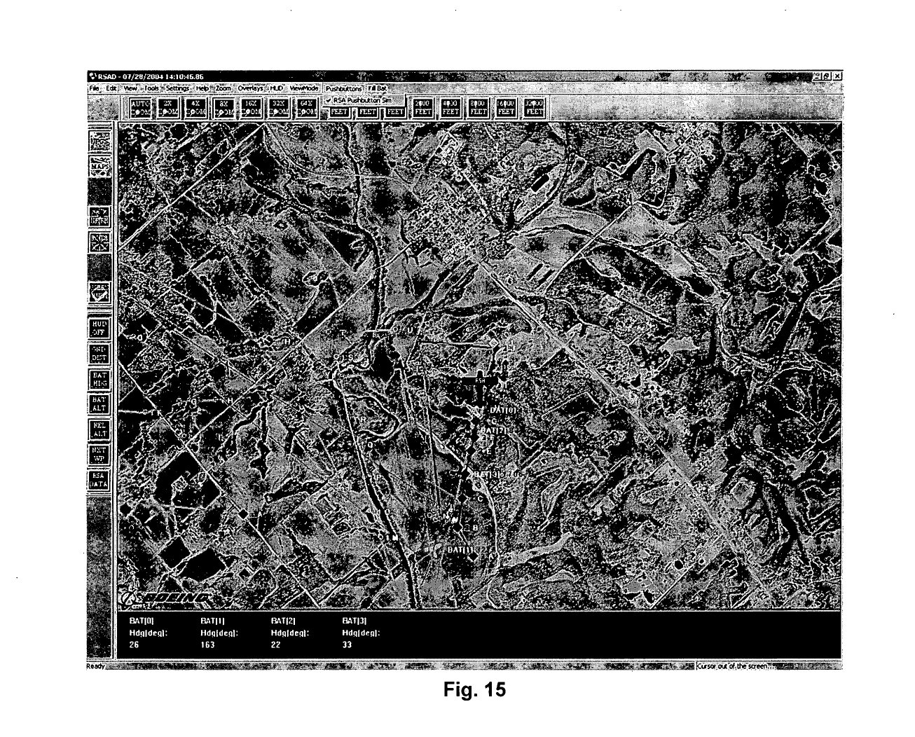

The OnDraw function updates the map centering position and the view mode of the display. For example, if the observation platform is to be positioned at the center of the display, OnDraw pans the map relative to the observation platform's fixed position at the center of the display. The view mode can be, for example, either north mode or rotating mode. In north mode, the map is oriented such that north is at the top of the display, and the image of the observation platform rotates on the screen. In rotating mode, the image of the observation platform points toward the top of the screen and the map rotates about the fixed image of the observation platform. Thus, OnDraw updates the map centering position and the view mode of the display each time the watchdog timer times out. FIG. 15 is an illustrative screen shot showing a portion of a map in rotating mode, with the observation platform positioned at the center of the screen. As depicted, an unmanned air vehicle is positioned just behind the observation platform. The respective flight paths for the observation platform and unmanned air vehicle, including the unmanned air vehicle's waypoints, are also shown.

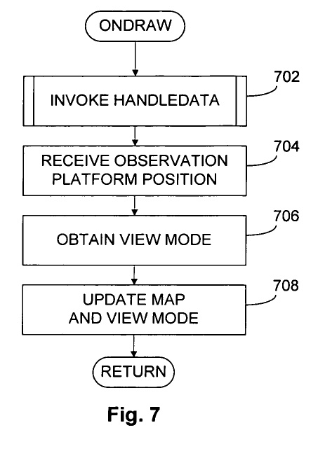

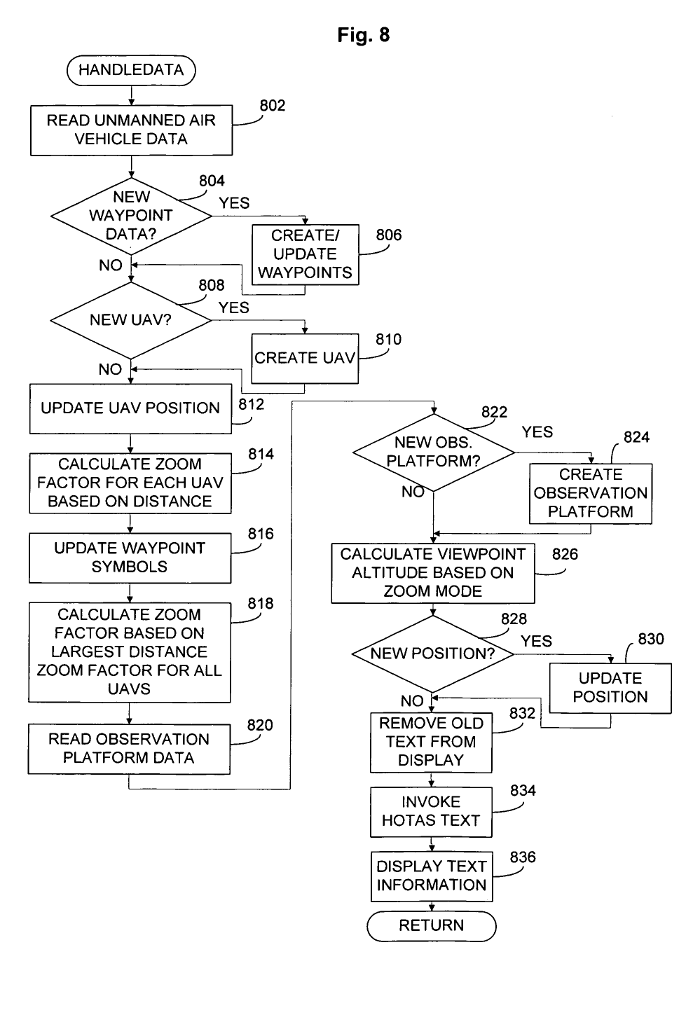

FIG. 7 is a flow diagram illustrating exemplary steps performed by the OnDraw function. First, the OnDraw function invokes the HandleData function to obtain the current position of the observation platform (step 702). As will be described below with reference to FIG. 8, the HandleData function reads the current position of the observation platform from memory and passes the information back to the OnDraw function. The OnDraw function then receives the current observation platform position information from the HandleData function (step 704).

Then, the OnDraw function obtains the view mode (step 706). In the illustrative example, the view mode is either north mode or rotating mode. As described below, the user can select the view mode using, for example, an on-screen menu or pushbutton toolbar selection. When the user selects a view mode, the view mode is stored in a variable, which can be obtained by the OnDraw function.

After receiving the current observation platform position and obtaining the view mode, the OnDraw function updates the map on the display (step 708). For example, if the view mode is north mode, then the OnDraw function orients the map to point to the north and pans the map relative to the current position of the observation platform, which is located at the center of the screen. If the view mode is rotating mode, then the observation platform points to the north at the center of the screen, and the map rotates according to a ground-based vector of positional movement of the observation platform.

FIG. 8 depicts a flow diagram illustrating exemplary steps performed by the HandleData function. The HandleData function handles the drawing and positioning of the observation platform and unmanned air vehicles on the display. As HandleData is invoked by OnDraw in step 702, HandleData is invoked each time the watchdog timer times out. As discussed above, the data processing systems on the observation platform and unmanned air vehicles transmit data about those platforms to the situation awareness display, where the data is stored at predetermined memory locations. HandleData reads the data from the observation platform and unmanned air vehicles from the memory.

As shown in FIG. 8, HandleData reads the data for the unmanned air vehicle from memory (step 802). In the illustrative example, HandleData reads the data items identified in FIG. 5, such as latitude, longitude, altitude and waypoint data for the unmanned air vehicles beginning at memory location 1000. If there is new waypoint data for an unmanned air vehicle (step 804), then HandleData associates the new waypoints with the respective unmanned air vehicle by updating a profile for the unmanned air vehicle (step 806). The profile includes a data structure including the unmanned air vehicle's data that was read from memory and a symbol for presentation on the display. If there is a new unmanned air vehicle (step 808), HandleData creates a profile for the new unmanned air vehicle (step 810) and updates the profile with the data read from memory (step 812).

HandleData determines whether there is data for additional unmanned air vehicles in memory, for example, by reading a write count that is written to memory by the status program. The status program increments the write count when it writes the data for an unmanned air vehicle to the memory. Similarly, HandleData can increment a read count at a location in the memory for each unmanned air vehicle data that is read. If HandleData determines that the read count is less than the write count for a particular unmanned air vehicle, then Handle Data reads data for that unmanned air vehicle. As the memory locations for each unmanned air vehicle and observation platform are fixed in the illustrative example, HandleData knows where to locate the next data set by jumping to a memory location that is a predetermined number greater than the starting point of the previous data set. Accordingly, if there is data for a next unmanned air vehicle, HandleData looks to the appropriate memory location for that data set.

Then, HandleData calculates a zoom factor for each unmanned air vehicle based on the unmanned air vehicle's distance to the observation platform (step 814). This calculation is performed by comparing each unmanned air vehicle's location data to the location data of the observation platform. The waypoint symbols for each unmanned air vehicle are then updated and displayed (step 816). Then, HandleData calculates a zoom factor based on the largest zoom factor distance for all unmanned air vehicles (step 818). HandleData performs this calculation by identifying the largest zoom factor calculated in step 814.

HandleData then reads the data for the observation platform (step 820). In the illustrative example, HandleData reads the data for the observation platform beginning at a predetermined memory location, such as memory location 5001. If the observation platform is new (step 822), then HandleData creates a profile for the new observation platform (step 824). The observation platform profile comprises a data structure including the new observation platform's data that was read from memory and a symbol for presentation on the display. Then, HandleData updates the profile with the data read from memory and displays the observation platform at the center of the display. The symbol for the observation platform is displayed pointing toward the top of the screen in rotating mode or pointing in its compass direction in north mode.

HandleData then calculates the viewpoint altitude based on the zoom mode (step 826). In the Auto Zoom mode, HandleData calculates the distance from the observation platform to the farthest unmanned air vehicle. This is done by comparing the longitudinal and latitudinal coordinates of the observation platform to those of the unmanned air vehicles. The calculated distance is used when the user selects the display to be presented in Auto Zoom mode, in which the display is zoomed such that the observation platform and the unmanned air vehicles fill up the display. Alternatively, the user can select a zoom mode for either a static height or a multiple of the observation platform's current altitude. If the static height zoom mode is selected, then the selected height is used as the viewpoint altitude.

HandleData compares the unmanned air vehicles' and observation platform's current positions to their previous positions to determine whether the positions have changed (step 828). If a position has changed, HandleData updates the observation platform's or unmanned air vehicle's profile to reflect the change (step 830).

The situation awareness display can present text information regarding the observation platform and the unmanned air vehicles on the display. For example, HandleData can display a textual identification of a vehicle's position or status (e.g., “Altitude 500 ft”). However, the data that is read from memory is in a numerical format, which HandleData converts to a textual format for display. The data can be converted, for example, to the ASCII format.

Prior to displaying a text item, HandleData removes the old text items from the display (step 832). The, HandleData invokes the HotasText function to set up the text item as drawable text for the display (step 834). HotasText creates text variables from a drawable class for each text item to be displayed. The drawable class can be, for example, a subclass of the Autometric™ classes, and can include, for example, a label, a location, and a color for the text item. HotasText returns the text variables to HandleData, where the drawable text is received (step 828). HandleData then determines the values for the text variables, converts the values from numerical to textual format, and displays the drawable text on the display (step 836).

Referring back to FIG. 6, after OnDraw displays the map and HandleData displays the observation platform and unmanned air vehicles in step 608, the view class determines whether the user has selected to terminate execution of processing (step 610). If processing is not to be terminated, processing returns to step 606, otherwise the processing terminates.

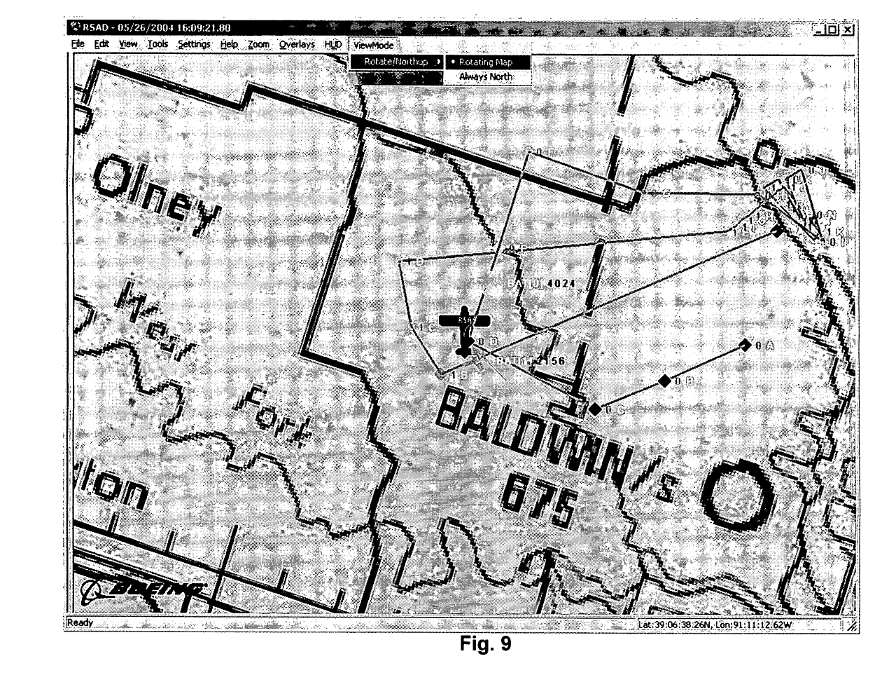

The situation awareness display can provide menu and toolbar functions that enable the user to select options for displaying information. The Menu functions of the view class and main frame class are invoked to perform the respective functions. For example, as shown in the screen shot in FIG. 9, menu items are presented on the display for selecting the view mode. When the user selects “Rotating Map,” OnDraw updates the map using rotating mode. And when the user selects “Always North,” the map oriented with north pointing to the top of the display.

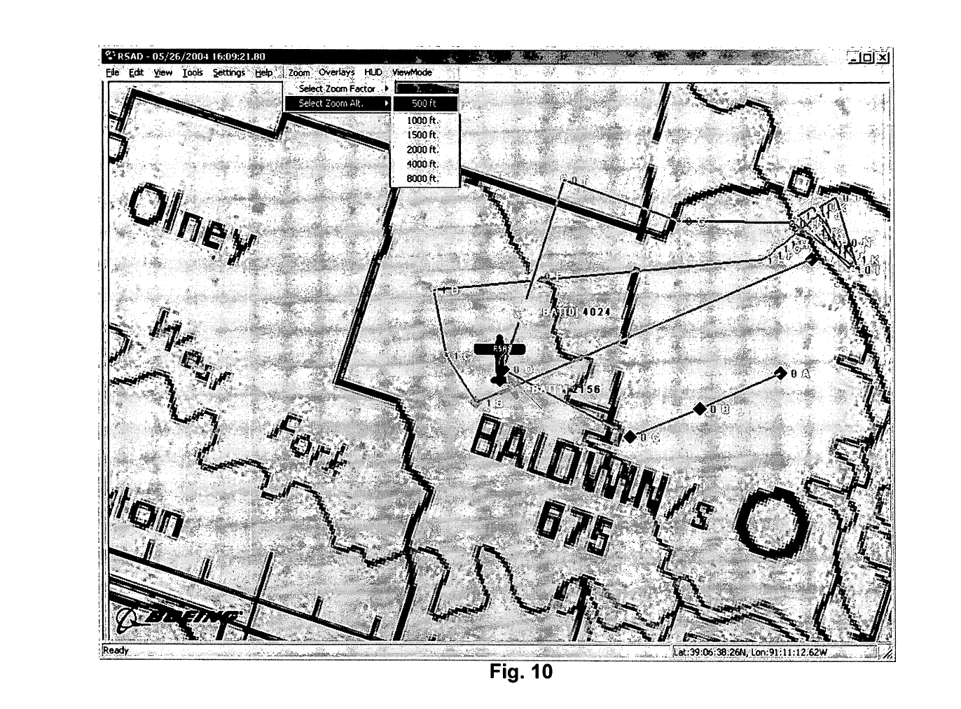

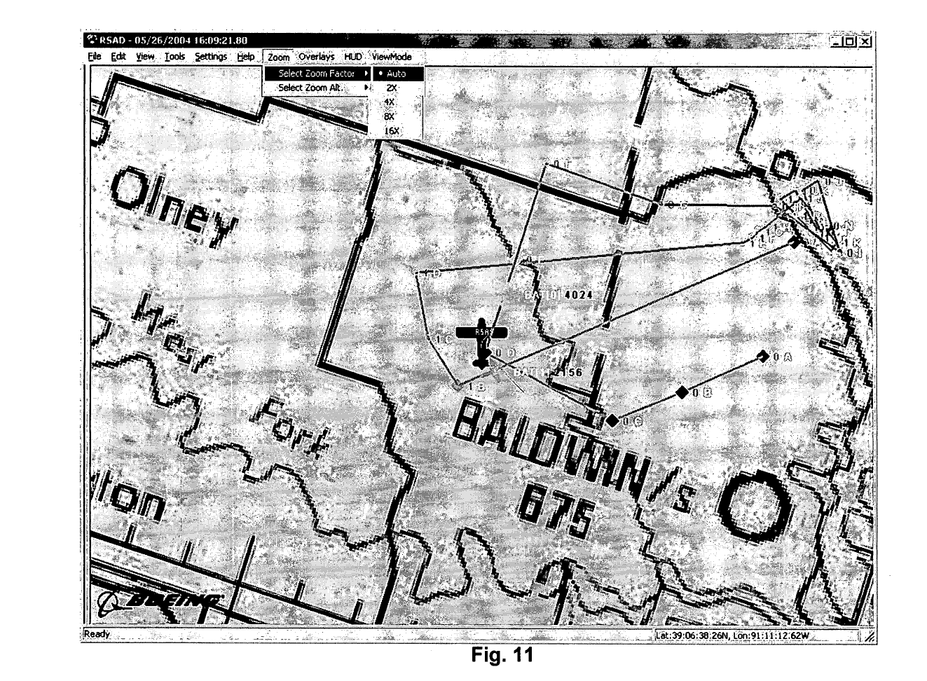

FIG. 10 depicts an illustrative screen shot depicting a menu item for selecting a static altitude Zoom mode, in which the altitude viewpoint is determined by the selected altitude from the menu. FIG. 11 depicts an illustrative menu item for selecting Auto Zoom mode or a Zoom factor zoom mode that is based on a multiple of the height of the observation platform.

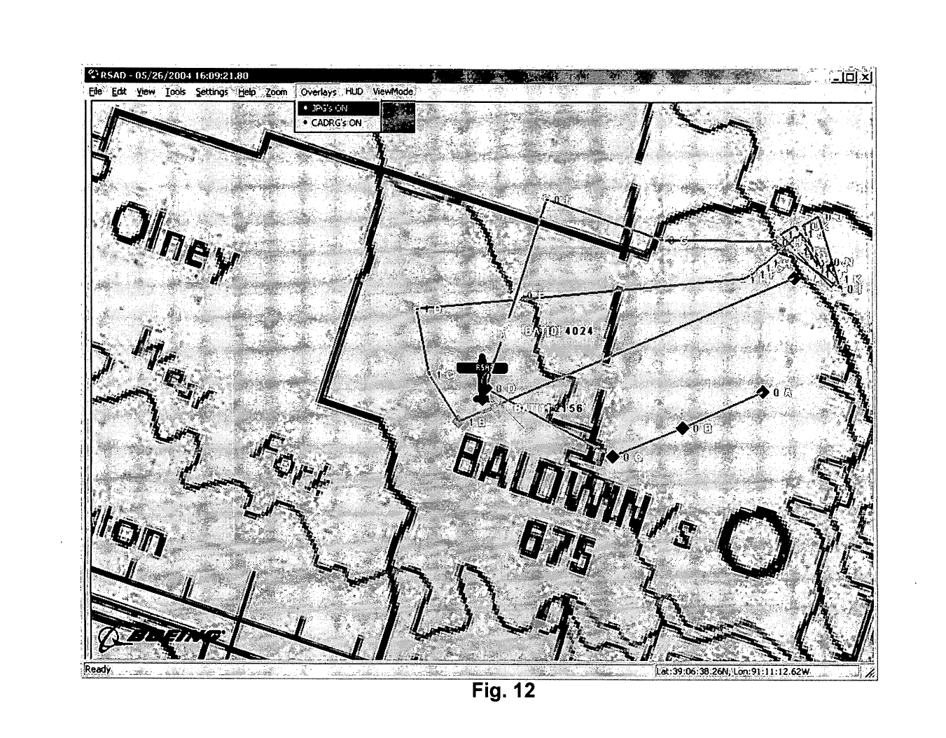

FIG. 12 is an illustrative screen shot depicting a menu item for toggling overlays, such as the map. In the illustrative example, there are selections for toggling the map and overlay image information. The map can be, for example, a compressed ADRG (CADRG) image file that is retrieved from secondary storage. Therefore, different maps can be retrieved depending on the relevant location. The overlay image information can be, for example, a JPEG or TIFF file that includes image information on roads, terrain, towns, or other information. In addition to the file formats identified, the map and overlay image information files can be in alternative formats, such as but not limited to BMP, CIB, DTED, GIF, ISOCON, MDA, NITF or RPF format.

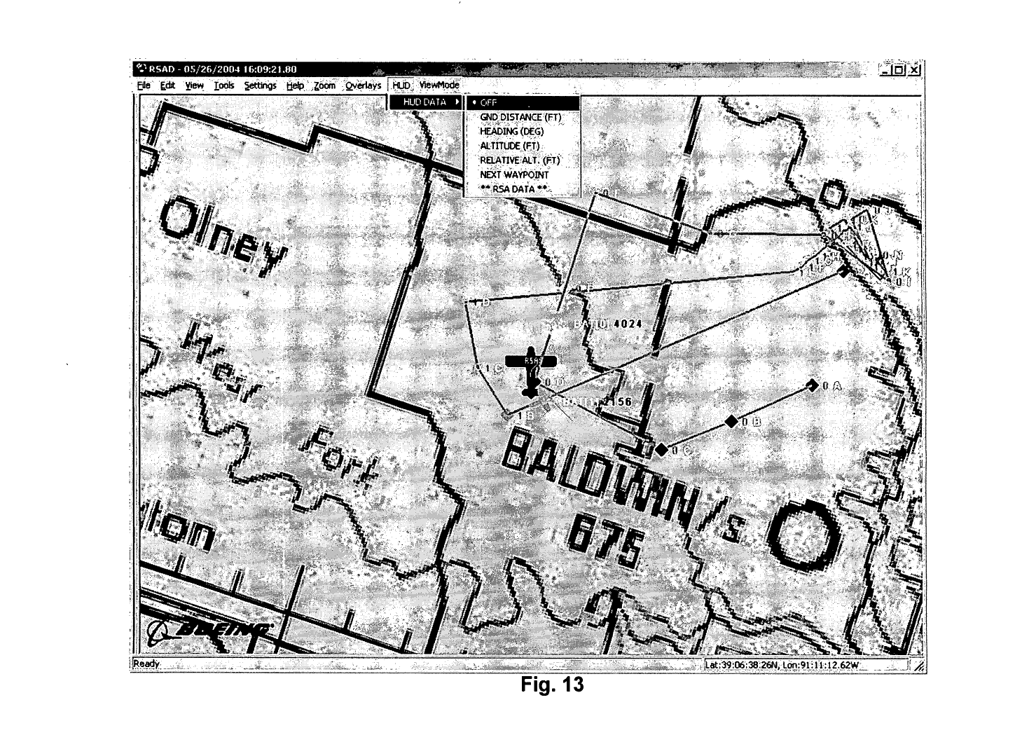

FIG. 13 depicts an illustrative screen shot displaying menu items for toggling heads-up-display (HUD) values. The illustrative HUD values include ground-based distance from the observation platform to each unmanned air vehicle, the course heading over ground for each unmanned air vehicle, the mean altitude over sea level (MSL) for each unmanned air vehicle, the relative altitude (MSL) for each unmanned air vehicle with respect to the altitude of the observation platform, the next mission waypoint for each unmanned air vehicle, the observation platform's position and map viewpoint status information, and a user's guide.

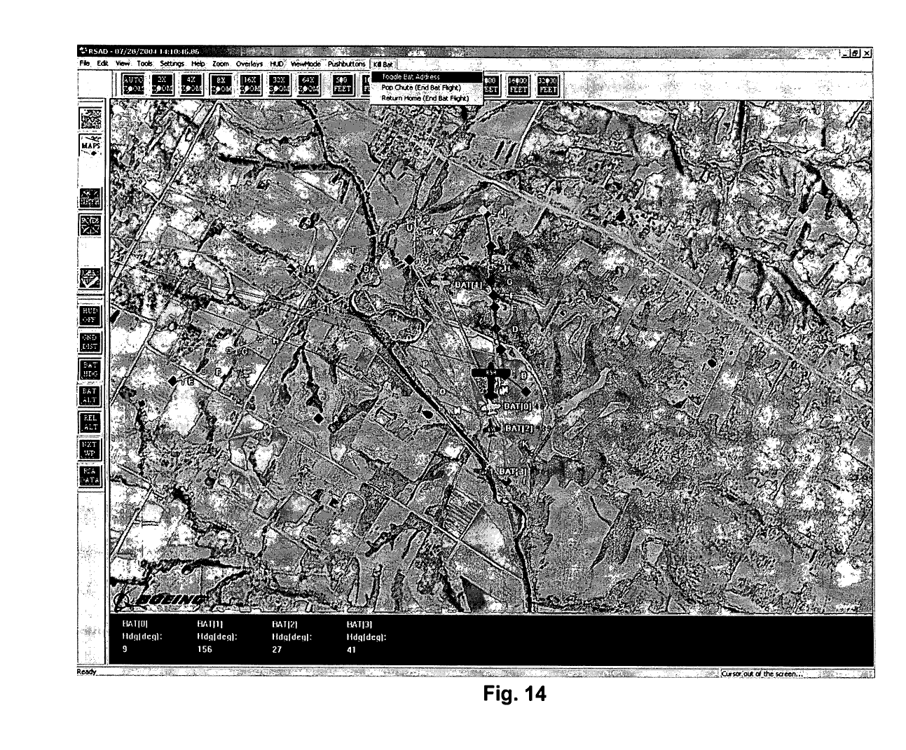

As shown in FIG. 14, menu items can be provided for selecting end mission functions. End mission functions enable the user of the situation awareness display to send commands to the unmanned air vehicles. Illustrative end mission functions include a command to pop the unmanned air vehicle's parachute and a command to return to the takeoff location. For example, if the user determines that there is a problem with the unmanned air vehicle or its mission, the user can command the unmanned air vehicle to return home. When the user selects an end mission function, a flag is placed in a predetermined memory location in memory that is associated with the corresponding unmanned air vehicle. Then, the update program transmits the flag to the appropriate unmanned air vehicle. Therefore, the flag is sent via modem 260 as a wireless signal to the unmanned air vehicle, where it is received.

The embodiment shown in FIG. 15 includes pushbuttons positioned around the display. The pushbuttons buttons can mimic the above-described menu selections. In FIG. 15, the illustrative example includes pushbuttons for zoom and viewpoint altitude selections across the top of the display and additional toolbar buttons on the left-hand side of the display. The display of the pushbuttons can be toggled on and off.

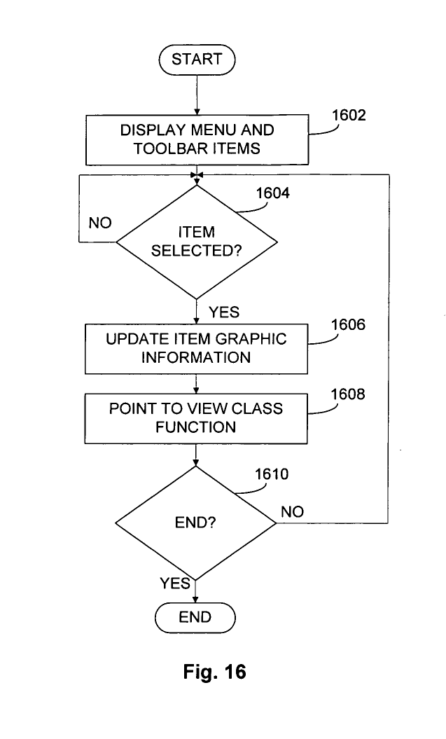

In the illustrative example, the menu and toolbar items correspond to Menu functions of the main frame class. The main frame class displays the menu and toolbar items on the display and receives user input selection of the menu and toolbar items. FIG. 16 depicts a flow diagram illustrating exemplary steps performed by the main frame class. First, the main frame class displays the menu and toolbar items on the display (step 1602). If the user selects a menu or toolbar item (step 1604), for example by clicking on the item with the mouse, then the main frame class updates the display of the item (step 1606). For example, if the user toggles a menu item for Auto Zoom mode, then the main frame class can change the appearance of that menu item to indicate that it has been selected.

Menu functions of the main frame class may be associated with corresponding Menu functions of the view class. For example, the Auto Zoom mode menu item is associated with an identifier of a view class function that performs the Auto Zoom mode functionality on the display. In other words, in the illustrative example, the main frame class administers the display and selection of the menu and toolbar items, and the view class performs the functions identified by the menu and toolbar items. Therefore, when a user selects a menu or toolbar item in step 1604, the main frame class notifies the corresponding view class function (step 1608). Accordingly, the view class function performs the selected action. If the user has not selected to terminate execution of the main frame class (step 1610), then program flow returns to step 1604.

Therefore, the situation awareness display enables a user to track multiple unmanned air vehicles and the observation platform. Unlike conventional methods and systems that rely on line of sight or radar, methods, systems and articles of manufacture consistent with the present invention use global positioning system data that is received wirelessly from the unmanned air vehicles to track the unmanned air vehicles. Thus, a user of the situation awareness display consistent with the present invention is not hindered by viewing obstructions or the disadvantages of radar.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. Further, the illustrative processing steps performed by the program can be executed in an different order than described above, and additional processing steps can be incorporated. The invention may be implemented with both object-oriented and non-object-oriented programming systems. The scope of the invention is defined by the claims and their equivalents.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense

1. A method in a data processing system having a program for tracking an unmanned air vehicle, the method comprising:
receiving a location of an unmanned air vehicle wirelessly from the unmanned air vehicle, the location of the unmanned air vehicle being determined by a global positioning system on the unmanned air vehicle;
receiving a location of an observation platform from the observation platform, the location of the observation platform being determined by a global positioning system on the observation platform;
calculating a zoom factor for the unmanned air vehicle based on the unmanned air vehicle's distance to the observation platform; and
displaying the location of the unmanned air vehicle the locations of any other unmanned air vehicles and the location of the observation platform at the zoom factor.

2. A method of claim 1 further comprising receiving at least one waypoint location of a predetermined flight path of at least one unmanned air vehicle.

3. A method of claim 2 further comprising displaying the at least one waypoint location of the predetermined flight path of at least one unmanned air vehicle.

4. A method of claim 1 wherein the locations of each unmanned air vehicle and the observation platform are displayed on a map.

5. A method of claim 1 wherein the data processing system is located on the observation platform.

6. A method of claim 1 wherein the data processing system is located remote from the observation platform.

7. (canceled)

8. A computer-readable medium of claim 18, further comprising receiving at least one waypoint location of a predetermined flight path of the unmanned air vehicle from the unmanned air vehicle.

9. A computer-readable medium of claim 8, the data causing the system to display the at least one waypoint location of the predetermined flight path of the unmanned air vehicle.

10. A computer-readable medium of claim 18, wherein the unmanned air vehicle and the observation platform are displayed on a map corresponding to the location of the unmanned air vehicle and the location of the observation platform.

11. The system of claim 14, wherein the system is located on the observation platform.

12. The system of claim 14, wherein the system is located remote from the observation platform.

13. (canceled)

14. A system for tracking an unmanned air vehicle, the system comprising:
means for receiving a location of an unmanned air vehicle;
means for receiving a location of an observation platform;
means for calculating a zoom factor for the unmanned air vehicle based on the unmanned air vehicle's distance to the observation platform; and
means for displaying the location of the unmanned air vehicle and the location of the observation platform at the zoom factor.

15. (canceled)

16. A computer-readable medium of claim 18, wherein the memory includes a view class, the view class configured to periodically check for new location.

17. A computer-readable medium of claim 16, further including a main frame class, the main frame class configured to display menu and toolbar items on the display.

18. A computer-readable medium comprising memory encoded with data for causing a processing system to track at least one unmanned air vehicle, comprising:
receiving a location of an unmanned air vehicle wirelessly from the unmanned air vehicle;
receiving a location of an observation platform from the observation platform;
calculating a zoom factor for the unmanned air vehicle based on the unmanned air vehicle's distance to the observation platform; and
visually displaying the location of the unmanned air vehicle and the location of the observation platform.

19. A computer-readable medium of claim 16, wherein the view class updates the display placing one of the unmanned air vehicle and observation platform in the center of the display.

20. (canceled)

21. The computer-readable medium of claim 18, when a zoom factor is computed for each of a plurality of unmanned air vehicles, each zoom factor based on distance to the observation platform; and wherein the unmanned air vehicles and the observation platform are displayed using the largest zoom factor.

22. The method of claim 1, when a zoom factor is computed for each of a plurality of unmanned air vehicles, each zoom factor based on distance to the observation platform; and wherein the unmanned air vehicles and the observation platform are displayed using the largest zoom factor.

23. The system of claim 14, when a zoom factor is computed for each of a plurality of unmanned air vehicles, each zoom factor based on distance to the observation platform; and wherein the unmanned air vehicles and the observation platform are displayed using the largest zoom factor.
